(19) United States
(12) Patent Application Publication
(10) Pub. No.: US 2025/0050316 A1
(43) Pub. Date: Feb. 13, 2025

(54) UV-PROTECTION OF PHOTOSENSITIVE PIGMENTS VIA INCORPORATION INTO METAL ORGANIC FRAMEWORKS (MOFS)

(71) Applicant: The Government of the United States of America, as Represented by the Secretary of the Navy, Arlington, VA (US)

(72) Inventors: Christopher Breshike, Spotsylvania, VA (US); Chris Kendziora, Burke, VA (US); R. Andrew McGill, Wasington, DC (US)

(21) Appl. No.: 18/626,318

(22) Filed: Apr. 3, 2024

Related U.S. Application Data
(60) Provisional application No. 63/456,873, filed on Apr. 4, 2023.

(51) Int. Cl. B01J 31/16; B01J 31/22; B01J 35/30; B01J 35/61

(52) U.S. Cl. CPC B01J 31/1691; B01J 31/226; B01J 35/393; B01J 35/61; B01J 2531/26

(57) ABSTRACT

A method of preventing photodegradation of dyes and pigments used in textiles and paints by surrounding photosensitive molecules with metal clusters that can absorb the damaging ultraviolet photons before they reach and damage the photosensitive molecules. A photosensitive dye or pigment is incorporated into a metal organic framework, which provides a scaffold to offer protection from ultraviolet degradation either by preferentially absorbing the ultraviolet light or by reflecting it before it reaches the dye. Isolating the dyes inside of the metal organic framework also sharpens the spectral features of the dye molecules.

### CROSS-REFERENCE

This application is a nonprovisional application and claims the benefit of U.S. Provisional Application Ser. No. 63/456,873, filed Apr. 4, 2023, entitled “UV-PROTECTION OF PHOTOSENSITIVE PIGMENTS VIA INCORPORATION INTO METAL ORGANIC FRAMEWORKS (MOF'S),” by Christopher Breshike, et al. This provisional application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; nrltechtran@us.navy.mil, referencing Navy Case #211455-US2.

### TECHNICAL FIELD

The present invention relates to preventing photodegradation of dyes and pigments used in textiles and paints.

### BACKGROUND

Department of Defense (DoD) equipment is often painted or otherwise colored for purposes that include camouflage, aesthetics, or even temperature control. Other applications involve encoded spectral signatures for taggants or stealthy detection methods. In all of these applications, photobleaching of the colors eliminates the utility and requires either maintenance in recoloring/dyeing/painting or complete replacement of the equipment.

There are several methods currently implemented to prevent photodegradation in dye molecules. These methods include the use of polymer stabilizers, protective coatings over the colored surface, or the use of other pigments. Depending on the end application there are two general ways to introduce UV blockers to a dye or pigment:
Mixing in light blocking/absorbing materials in solution with the dyes of interest.
Applying a protective coating after the application of the dye/pigment to a surface.

For instance, the paints on automobiles are typically applied, allowed to dry and then a clear coating of UV-blocker is applied to the surface. For most DoD applications this is not as desirable since the protective coating is typically “shiny” which decreases the stealth of the painted surface and might mask the spectral features for which the dye/pigment was designed. This method is also not applicable to clothing or textile-based equipment. Such equipment is typically dyed or colored during the manufacturing process and the UV-blockers must be part of the overall solution or ink mixture. Care must be taken when preparing the inks containing pigments and the UV blockers and any solvents necessary in the manufacturing process to make sure the mixtures are homogeneous. Different colors of dyes or pigments might require different formulations to get similar results and in most cases the color of the pigmented is muted by the “white” UV blockers in the mixture.

The present invention offers a third method of protection. Encapsulating the dyes or pigments in molecular cages formed by metal organic frameworks (MOFs) offers a 3-dimensional barrier around individual molecules that absorbs incoming UV photons before they reach the photosensitive species. MOFs provide a customizable scaffold structure for adsorbent applications. MOF structures and pore sizes are highly tunable by modifying the metal nodes and organic linkers. Surface areas of MOFs range from 10²-10⁴ m²/g. Some MOFs exhibit excellent chemical stability. Post-synthetic modification allows for customization without damaging the core MOF's structure or properties. The present invention uses MOFs as a UV light barrier for dyes contained inside the MOF.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The fading of color from materials or paints from government and personal items affects the overall performance and appearance of those items. One mechanism for fading is photodegradation or photobleaching. This process occurs when dyes/pigments in an excited state (from the absorption of a photon) fails to relax back down to the ground state and instead the energy from the excited state is either trapped to a local minimum or is used to cleave bonds in the molecule. The result of this process is a material with less vivid color and can eventually lead to completely white materials with no color. For many applications, this can result in the end of life for a given item. This is especially true for any camouflaged equipment, including uniforms. The purpose of this invention is to protect photosensitive dyes or pigment from photodegradation from UV light by encapsulating them in the pores of or chemically grafting them directly to the structure of a metal organic framework (MOF). This protection is the result of the MOF providing additional pathways for an excited electron from the dye/pigment to relax back down to the ground state or simply blocking the ultraviolet (UV) photons from getting to the photosensitive molecules via absorption, reflection, or scattering. This invention should extend the life of textile-based equipment that has been dyed for a given application and reduce the maintenance costs for paints by extending the periods where it needs to be reapplied.

Conventional methods to protect pigments and dyes from photodegradation have reasonably good performance but require new formulations for every system. One of the benefits from this invention is that the surface chemistries, and therefore any formulation requirements, will be dependent on the scaffold material. Therefore if a series of dyes can be isolated in UiO-66, as an example MOF, then any formulation process that can incorporate UiO-66 will work for all of them.

Another advantage is the band narrowing of the spectral features. Materials with narrow spectral features can be more easily transitioned into detection/taggant systems because they offer better contrast than broader features. For visual dyes this spectral narrowing also results in a more vivid color.

### BRIEF DESCRIPTION OF THE DRAWINGS

FIG. 1 depicts a dye contained in a MOF structure for protection from a UV photon.

FIG. 2 depicts the spectral difference between an isolated dye (Cy5.5) molecule (bottom) and the same dye in bulk (top). The thicker lines are each species before UV dosing, and the thinner lines were measured after 2 hours of UV dosing.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

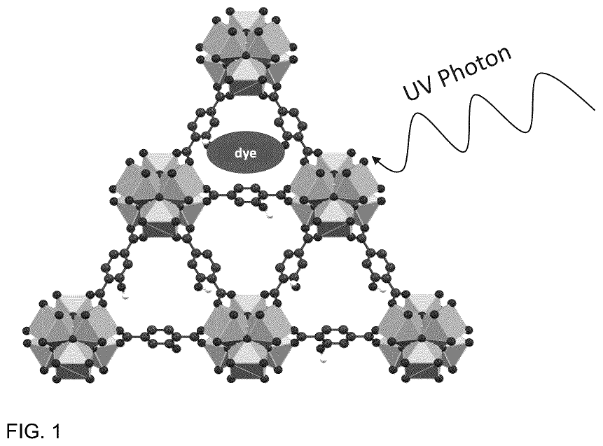

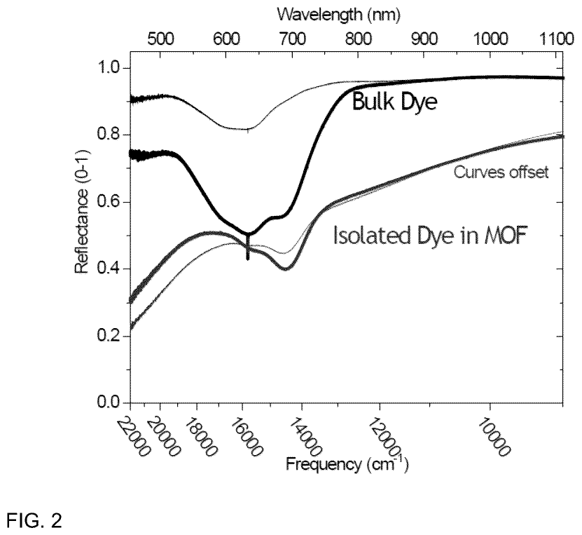

The present invention incorporates a photosensitive dye or pigment into a solid molecular scaffold framework containing metal nodes, such as a MOF (FIG. 1). This scaffold framework offers protection from UV degradation by preferentially absorbing the UV light or reflecting it before it reaches the dye. Spectrally interesting molecules like dyes or pigments are isolated in the pores of a MOF to protect them from UV induced photodegradation. The dyes or pigments can be visible or infrared active. Isolating the dyes inside of the pores of the MOF also sharpens the spectral features of the dye molecules by eliminating the spectral broadening that occurs in high concentration environments. For visible dyes and pigments, this sharpening results in more vivid colors, as opposed to the muted colors associated with mixtures that include traditional UV blockers. FIG. 2 illustrates both concepts of protection from UV degradation and spectral sharpening for a commercially available off-the-shelf (COTS) dye known as Cy5.5. The top curves are reflectance measurements of a sample of Cy5.5 deposited onto a white sheet of paper. The bottom curves are reflectance measurements of a sample of Cy5.5 that has been isolated in a derivative of a MOF called UiO-66. The thicker lines were measured before exposure to UV radiation and the thinner lines were measured after two hours of UV exposure. The bulk, unprotected dye exhibits a dramatic increase in reflectance, corresponding to about an 80% drop in absorbance after 2 hours of UV exposure. The dye isolated in the pores of the MOF exhibited a much smaller increase in reflectance, corresponding to less than a 10% drop in absorbance after UV exposure and has a full width half max (FWHM) that is sharpened to about 30% of the bulk FWHM. The overall absorption is less in the isolated dyes simply because there is less dye present in the measurement, as the majority of the sample is composed of the MOF.

Isolation of the dye molecules can be accomplished in two manners. The first is to perform post-synthetic modification on an already formed MOF so that the dye molecules are attached directly to the structure of the MOF. In a preferred embodiment, the dye molecules are covalently grafted to the MOF. This requires special modification to the dye and the MOF structure and can affect the spectral properties of the dye. There are a number of established chemistries that could be utilized in the post-synthetic modification method including but not limited to; “click” chemistry between an azide and an alkyne, condensation reactions between amines and carboxylic acids, or one could attach to the metal node of the MOF scaffold via coordination chemistry. The other method for isolation is to form a concentrated solution of the dye and form the MOF around the dye molecules. This method is simpler but uses more dye materials in the isolation process as high concentration is required to ensure the MOF will trap dye molecules in its pores during formation. In another embodiment, the MOF is produced in particle sizes that may be incorporated or affixed into other materials such as a solid or liquid polymer or a polymeric based fibrous material.

### Alternatives

There are thousands of different MOFs that might also work and be worth investigating to maximize the UV protection. In general, the literature has shown that zirconium-based MOFs are the most stable under high temperatures and in a range of chemical environments but other metals might be worth pursuing if the final application does not require high temperature stability of the system. For instance, it is unlikely a piece of fabric will be required to withstand 300° C., so for clothing applications it might be worth investigating the aluminum or magnesium-based MOFs.

Along with exchanging the metal cores, there is a plethora of organic linkers in use in MOFs and longer linkers should certainly be used for larger dye molecules. Presented here is just the proof of concept of a cyanine dye which is about 8 angstroms long being isolated in UiO-66's pore which has a diameter of about 8 angstroms. A larger dye, such as phenothiazines, will require MOF structures with larger pores like those of NU-1000 or MOF-808.

Thus far as proof of concept, we have just either encapsulated or attached the dye to the organic linker via “click” chemistry. There are many different ways to form chemical bonds and many of them might be utilized to realize the isolation of a dye molecule in a MOF. Condensation reactions between amines and carboxylic acids, peptide bond formation, imine formation, or any single site modification method could be used. Another alternative could be coupling to the metal node of the MOF, instead of encapsulating or attaching to the organic linker directly. This would need to utilize coordination chemistries, as opposed to the formation of covalent bonds on the linker. For the zirconium-based MOF system, dyes modified with carboxylic acid or sulfate groups would be good candidates for coordinating modifications. For other metals, we would need to consult ligand field theory for the optimal design.

Although particular embodiments, aspects, and features have been described and illustrated, one skilled in the art would readily appreciate that the invention described herein is not limited to only those embodiments, aspects, and features but also contemplates any and all modifications and alternative embodiments that are within the spirit and scope of the underlying invention described and claimed herein. The present application contemplates any and all modifications within the spirit and scope of the underlying invention described and claimed herein, and all such modifications and alternative embodiments are deemed to be within the scope and spirit of the present disclosure.

What is claimed is:

1. A method of protecting photosensitive molecules, comprising isolating photosensitive molecules within a solid molecular scaffold framework containing metal nodes.

2. The method of claim 1, wherein the solid molecular scaffold framework is a metal organic framework structure.

3. The method of claim 1, wherein the photosensitive molecules would be damaged by ultraviolet light when not protected by the solid molecular scaffold framework.

4. The method of claim 1, wherein the photosensitive molecules comprise a visible or infrared active dye.

5. The method of claim 4, wherein the visible or infrared active dye is covalently attached to the solid molecular scaffold framework.

6. The method of claim 4, wherein the visible or infrared active dye is encapsulated inside pores of the solid molecular scaffold framework but is not covalently grafted to the solid molecular scaffold framework.

7. The method of claim 6, wherein the visible or infrared active dye is encapsulated inside the solid molecular scaffold framework during the process to form the solid molecular scaffold framework.

8. The method of claim 4, wherein the visible or infrared active dye has spectral features that are sharpened relative to bulk solid state spectral features.

9. The method of claim 1, wherein the solid molecular scaffold framework is incorporated or affixed into a solid or liquid polymer or a polymeric based fibrous material.
